(19) United States
(12) Patent Application Publication
(10) Pub. No.: US 2003/0000182 A1
(43) Pub. Date: Jan. 2, 2003

(54) Packaging machine and apparatus for wraparound cartons

(76) Inventors: Pascal Portrait, Vendoeuvres (FR); Pascal Martini, Poingonnet (FR)

Correspondence Address: Michael Drew, The Mead Corporation, Legal Department, 4850-D North Church Lane, Smyrna, GA, 30080, US

(21) Appl. No.: 10/165,883

(22) Filed: Jun. 10, 2002

Related U.S. Application Data
(63) Continuation of application No. PCT/US00/33553, filed on Dec. 11, 2000.

(30) Foreign Application Priority Data
Dec. 10, 1999 (GB) 9929350.8

(51) Int. Cl. B31B 1/90; B65B 11/08

(52) U.S. Cl. 53/582; 53/589

(57) ABSTRACT

Apparatus to tighten opposed ends of a wraparound carton around an article in a stream of articles of variable size during continuous forward movement, the apparatus comprising one or more panel engaging elements to engage one end panel of the carton, a guide assembly to guide the engaged end panel into overlapping relationship with the opposed end panel held by the apparatus, and tightening device for tightening the carton panels around the article.

### STATEMENT REGARDING FEDERALLY-SPONSORED RESEARCH AND DEVELOPMENT

(Not applicable)

### CROSS-REFERENCE TO RELATED APPLICATIONS

This is a continuation of international application No. PCT/US00/33553, filed Dec. 11, 2000, which is pending at the time of filing hereof, and which international application claims priority based upon United Kingdom patent application serial number 9929350.8, filed Dec. 10, 1999, now abandoned.

### TECHNICAL FIELD OF THE INVENTION

The invention relates to a packaging machine which is especially suitable for processing packaging from blank to constructed and filled carton. The machine is readily adjustable to accommodate various carton types and also to allow the articles to pass through the machine without being packaged.

### BACKGROUND OF THE INVENTION

The majority of known packaging machines are dedicated machines that construct one type of carton and apply those cartons to articles of known size and shape. However, when articles are not of fixed dimensions then it becomes difficult to automate the packaging process. One such example is foodstuff, for example poultry.

It is an object of the present invention to provide a packaging machine which overcomes the technical disadvantages of known packaging machines and is capable of packaging articles that are not of known fixed dimensions.

A further problem associated with the prior art is that adjustment to machines usually requires removal of all the cartons within the packaging machine and possibly mechanical adjustment of components in the machine. During this changeover period a machine cannot be used (known as “downtime”) which is an expensive delay in the plant.

Therefore it is a further object of the present invention to provide a packaging machine which is capable of switching from one carton type or size to another or selecting articles to be packaged from a conveyor.

### BRIEF SUMMARY OF THE INVENTION

The present invention seeks to overcome, or at least mitigate, the problems of the prior art.

The present invention seeks to overcome these commercial disadvantages by providing one machine which is able to set up and load more than one type of carton.

One aspect of the invention provides an apparatus to tighten opposed ends of a wraparound carton around an article in a stream of articles of variable size during continuous forward movement. The apparatus comprises one or more panel engaging elements to engage one end panel of the carton, a guide assembly to guide the engaged end panel into overlapping relationship with the opposed end panel held by the apparatus. There further comprises a tightening device for tightening the carton panels around the article.

Preferably, the engaging element is mounted to the guide assembly moveable in a transverse direction to the carton feed path to engage the end panel.

Optionally, the transverse movement of the engaging element and guide assembly relative to the carton perpendicular to the carton feed direction is determined by cam means. Preferably, the cam means comprises a fixed cam track in which a cam follower attached to the guide assembly slidably fits.

According to an optional feature of this aspect of the invention, the tightening device causes the engaging element to move from a deployed position to a retracted position when the desired panel tension is reached thereby to release the engaged end panel. Optionally, the tightening device includes a resilient biasing means to cause the engaging element to move between retraced and deployed positions.

According to another optional feature of this aspect of the invention the guide assembly may be mounted on a continuous conveyor in a parallel plane to a carton conveyor.

According to a further optional feature of this aspect of the invention there may further comprise panel securing means to cause the opposing ends of the carton to be placed in face contacting relationship to be secured therewith.

According to a still further optional feature of this aspect of the invention, the panel securing means is further provided by a face of the guide assembly which face guides the overlapping panels in to abutment.

According to yet another optional feature of this aspect of the invention a glue gun may be provided to apply a layer of glue to one of the end panels to secure the end panels in overlapping arrangement.

A second aspect of the invention provides a packaging machine for continuously setting up and loading sleeve type cartons with one or more articles, for example, poultry comprising opposed side and end walls which machine comprises an article conveyor for conveying the articles through the machine. Carton feed apparatus is provided to sequentially to deliver successive cartons from a supply in flat collapsed condition to a setting up station of the machine and panel folding devices fold the carton into a set up wraparound condition. Support means is adapted to be brought into contact with the carton during movement downstream so that the carton is maintained in a set up condition and an article loading apparatus for loading at least one article into one or both ends of the carton. There further comprises a carton tightening apparatus to cause the opposing ends of the carton to overlap and securing means to cause the overlapping panels to engage thereby to secure the carton in a set up condition.

### BRIEF DESCRIPTION OF THE SEVERAL VIEWS OF THE DRAWINGS

Exemplary embodiments of the invention will now be described by way of example only, with reference to accompanying drawings in which:

FIG. 1 is a plan view of one type of carton supplied in a flat collapsed condition suitable for use with a machine according to the invention;

FIG. 2 is a perspective view of a machine according to one aspect of the invention;

FIG. 3 is a plan view showing the simplified packaging process in the machine as shown in FIG. 2;

FIG. 4 is perspective view of the carton supply infeed and set up stations of the machine shown in FIG. 2;

FIG. 5 is a perspective view of the article supply of the machine shown in FIG. 2;

FIG. 6 is a view of the outfeed end of the machine shown in FIG. 2;

FIGS. 7 and 8 illustrate the tightening apparatus adapted for use with the carton shown in FIG. 1.

### DETAILED DESCRIPTION OF THE INVENTION

The machine according to the embodiment of the present invention illustrated in the drawings is capable of securing different types and shapes of carton and loading one or more articles, for example foodstuff.

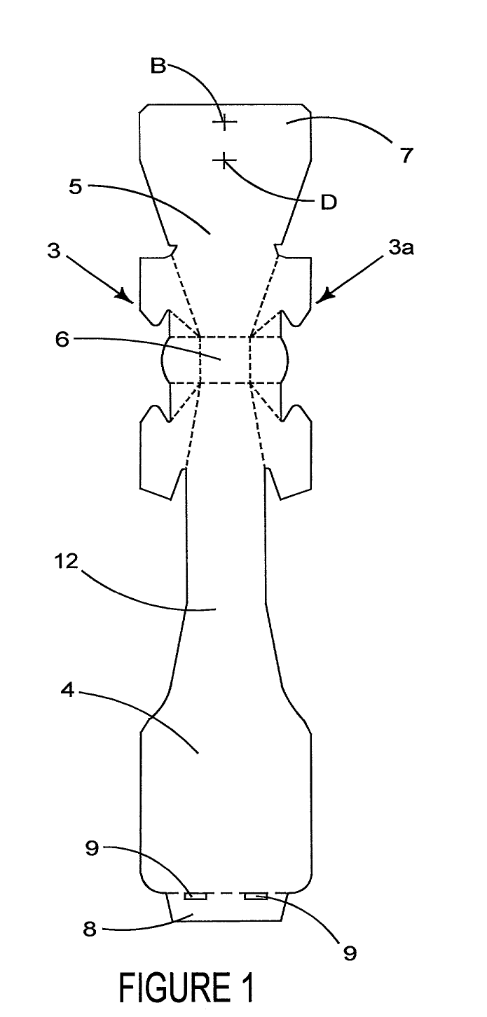

Referring to the drawings, and in particular FIG. 1 thereof, there is shown one example of a blank 12 for forming an article carrier for receiving the or each article. The blank is made from suitable foldable sheet material, for example paperboard. In the illustrated example the blank 10 includes a plurality of panels 4, 5, 6 hingedly connected one to the next to form a wraparound package. The blank 10 further includes opposed securing flaps 7, 8 to be secured together. Glue flaps are provided to secure the opposed end walls together. Panels 3, 3a are provided for forming end structures that are “cup-like” to receive and retain an article within the carton. Apertures 9 are provided to receive lugs from the machine during carton construction described below.

It is envisaged that the blanks can vary depending upon the shape and/or quantity of articles to be packaged and accordingly, a machine in accordance with the present invention is adjustable in numerous respects so that it can process a wide variety of such blanks.

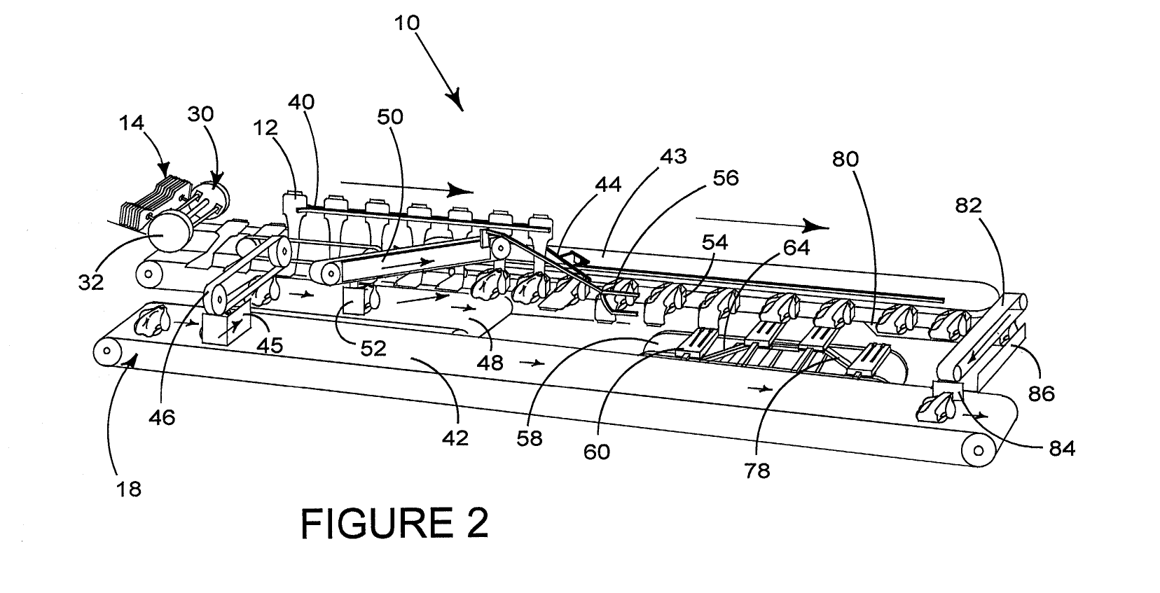

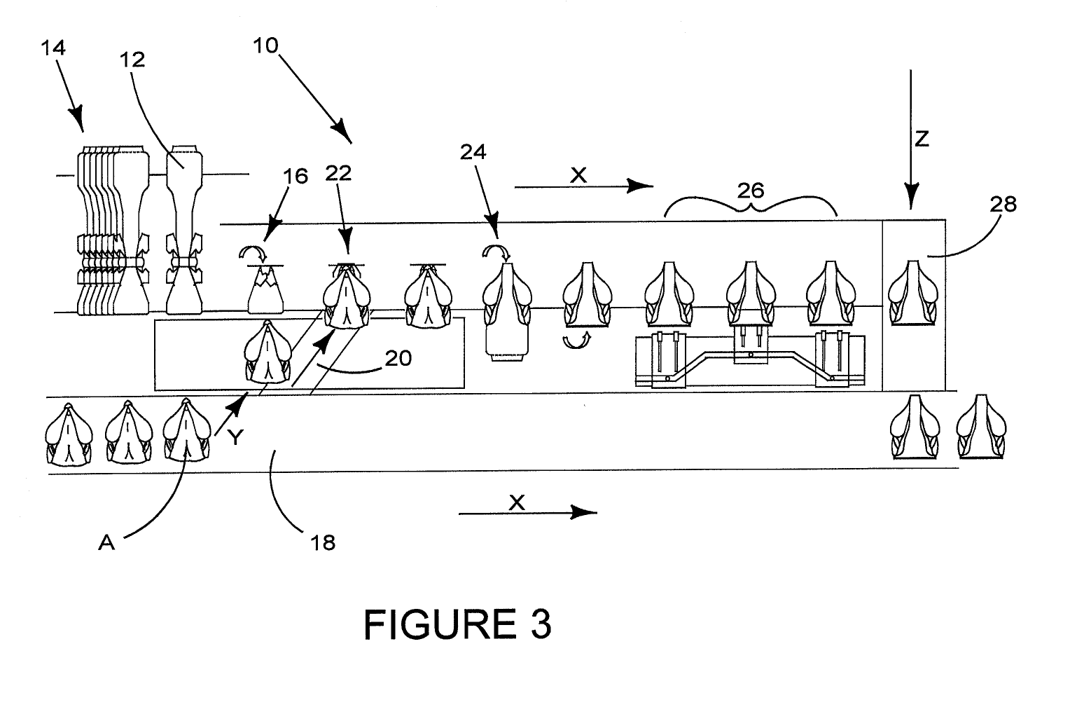

Referring now to FIGS. 2 and 3 of the drawings, there is shown a machine 10 for processing cartons from blanks, an example of which is outlined above. The packaging machine is capable of continuously setting up and loading cartons and comprises an article conveyor 18 for conveying articles A through the machine, carton feed apparatus 14 sequentially to deliver successive blanks 12 from a supply in flat collapsed condition to a carton set-up station 16 of the machine. One or more panel folding devices 36, 40 are used to fold the blank so as to be wrapped around the article, support means 54 adapted to be brought into contact with the carton during movement downstream so that the carton is maintained in a set up condition. An article loading station 24 is provided for loading at least one article into the part erected carton. Thereafter the ends of the carton are secured together at the carton securing station, before being returned to the conveyor 18 at the outfeed end of the machine.

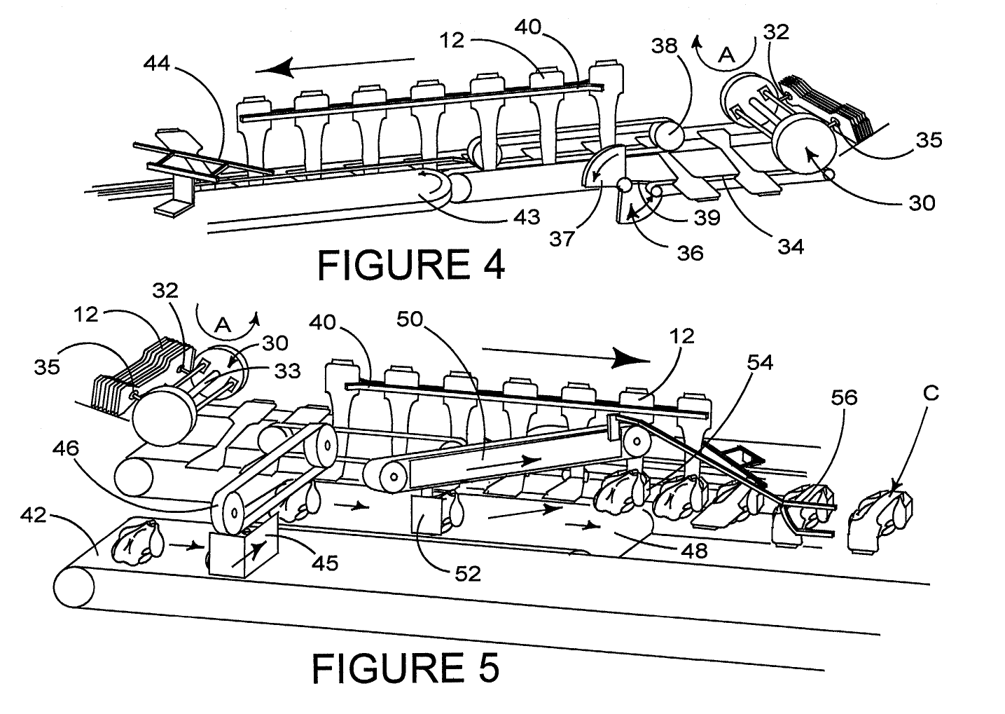

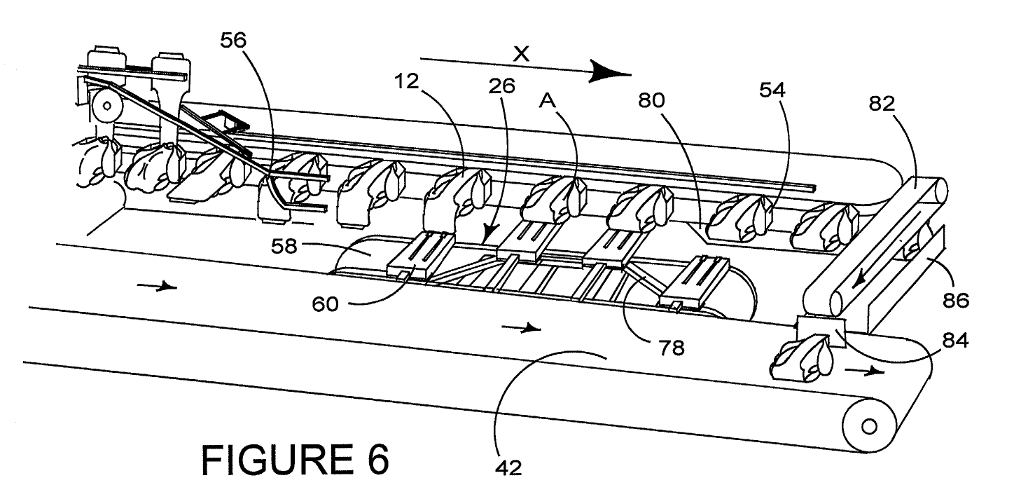

Turning to the construction of the machine of the present invention in more detail; the upstream end of the machine is described with reference to FIGS. 4 and 5 which shows the carton feed apparatus 14 comprises a hopper that holds a multiplicity of cartons C in flat collapsed condition are held ready for processing. The cartons are removed from the hopper 14 sequentially by a feed mechanism 30, which in this embodiment is a rotary vacuum feeder 32, as is well known in the art.

Whilst the use of a rotary vacuum feeder 32 to supply cartons to the conveyor is preferred, it is envisaged that the present invention can be used with other types of known feeder mechanisms without departing from the scope of the invention.

Preferably, the hopper 14 is a “gravity feed” type whereby the carton blanks 12 are held in the hopper 14 at an incline to provide a positive feed.

In use, the rotary feeder 32 continuously and sequentially feeds cartons from the hopper 14 to the infeed end of the machine and comprises a main shaft 33 mounted in a horizontal plane, that rotates pick up means 35 in the direction indicated by the arrow “A”, shown in FIG. 4. As the pick up means 35 rotates, suction cups (not shown) are moved in contact with a wall of blank 12. A vacuum is then applied to the set of suction cups by the vacuum supply, as is well known, and the blank 12 is withdrawn and then transferred onto an endless conveyor 34 to move the carton downstream in a continuous forward direction to a carton set up station 16 and onto the loading station 22, shown in FIG. 2.

The carton set up station 16 includes a plurality of panel folding devices 36, 38, 40 that are used for blanks that are required to be folded into a wraparound structure. The folding devices are used to perform two folding actions on the carton. First the blank 12 is gripped by gripping means, for example conveyor belts 38, shown in FIG. 4. The first folding device 36 folds the blank about the fold line between the panels 5 and 6 and into a substantially perpendicular relationship such that panel 4 is in a substantially vertical plane to be held in place by guide means 40. Thereafter the second folding device 43 and 54 causes the end structures formed from panels 3 to be set up.

As shown in FIG. 4, the folding device 36, in this embodiment, comprises a disc 37 mounted to suitable drive means (not shown), for example a servo motor. The motor is controlled by suitable control means, which can cause the rotational velocity of the disc to be varied. The disc 37 is preferably ‘segment’ shaped to define a leading edge 39 that contacts the blank to commence the folding. Thereafter, the inner surface of the wheel abuts the panel 4 to be folded and causes it to continue to be folded as described above. The panels 4 and 8 of the blank are held in place by a fixed guide 40.

Second folding device 43, 54 comprises a carton support lug 54 which is preferably shaped to conform to the shape of the end structure of the carton. In this embodiment, the lug is cup shaped to cause the end panels 3, 3a to be formed and to support panels 5, 6 and 4. The carton support 54 is mounted to an endless conveyor, for example a side lug chain assembly 43. Thus, as the blank 12 engages the support lug the panels 3 and 3a are caused to be folded out of alignment and thereby come into contact with the cupped surfaces. The end structure is formed into a recessed portion to receive part of the article at the loading station 22.

In order to complete the construction of the carton into a set up condition the part erected carton and lug 54 are moved downstream by the conveyor 43. The blank may be supported and moved forward by another suitable conveyor to maintain alignment between panels 5 and 4. The side lug chain assembly is driven by a suitable drive means which is controlled by a controller. Fixed guides (not shown) may be provided to minimise upward movement of the carton.

It will be seen from FIG. 5 that the part erected carton C is pushed forward towards the loading station 22 to be loaded with one or more articles. In this embodiment, the machine is adapted to load poultry into the carton.

The articles are supplied to the loading station on a second conveyor 18 which runs parallel to and may be synchronised in the same direction X with the first conveyor 16. In some embodiments, the articles are separated by known metering means. The present invention is also capable of switching between an operative condition, whereby articles A are selected from the conveyor 18 to be transferred to the loading station, and an inoperative condition, whereby the articles pass through the machine on the conveyor 18, without being packaged by an outer carton C.

In an operative condition, an article transfer mechanism 20 is provided to push the selected articles towards the carton in direction Y, shown in FIG. 3. In the embodiment illustrated in FIGS. 2 and 5, the mechanism 20 comprises a plurality of guide elements 45 mounted to an endless chain 46 to impart lateral movement to the article thereby to remove it from the second conveyor 18. The endless chain 46 is driven by suitable drive means to be synchronised with the article conveyor 42 and an intermediate conveyor 48.

The intermediate conveyor 48 may be provided where, for example, the first and second conveyors 16, 18 are not synchronised. The article is conveyed downstream to the transfer device 20. In this embodiment, the transfer device is an overhead chain assembly 50 with a plurality of lugs 52. However other known types of conveyor can be used without departing from the scope of invention. The lugs 52 engage the article and transfer the article in continuous forward movement to the loading station 22. The lugs 52 are preferably synchronised with the movement of the carton C and are angled with respect to the forward movement to cause the article and carton to gradually engage as shown in FIG. 5.

Thereafter, the carton C and article continue downstream by the lug 54 and conveyor 43 and the carton formation is continued, whereby guides 44 and 56 engage panel 4 to fold it about the article A to be wrapped around it as shown in FIG. 2. The end panels 7, 8 of the carton are secured together to complete the packaging process.

As the articles processed by the machine of the present invention are likely to vary in size, it is difficult to produce a standard carton for the article that will keep it securely packaged. Therefore it is desirable to incorporate another aspect of the invention which is a carton tightening device, designated as 26 in FIG. 3. In broad terms, the device 26 engages one end of the carton and pulls it towards the opposing end of the carton, until the carton reaches the desired level of tension. The ends 7, 8 are in an overlapping arrangement so that they can be secured together by glue or other suitable means known in the art. Therefore, if the article is small, the end panels 7 and 8 of the carton are caused to overlap by a greater distance than if the article is larger. FIG. 1 illustrates two possible positions B and D of the position of end panel 8 on panel 7: position B is when the article is large and position D is when the article is smaller.

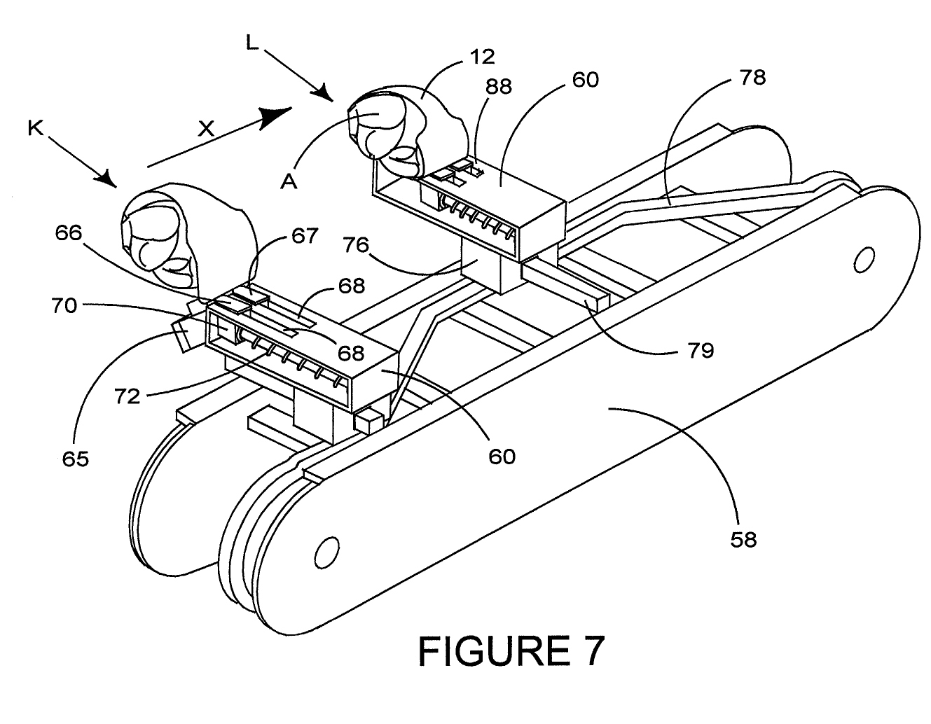

The preferred configuration of the carton tightening device 24 is illustrated in FIGS. 6, 7 and 8. The device comprises a plurality of guide assemblies 60 mounted on an endless conveyor 58. The endless conveyor is parallel to conveyor 16 so that the guide assemblies are moved in the same direction X as the article and carton. Suitable drive means drives the conveyor 58 and a controller is provided to control the position and velocity of the guide assemblies so as to be synchronised with the carton C and lug 54.

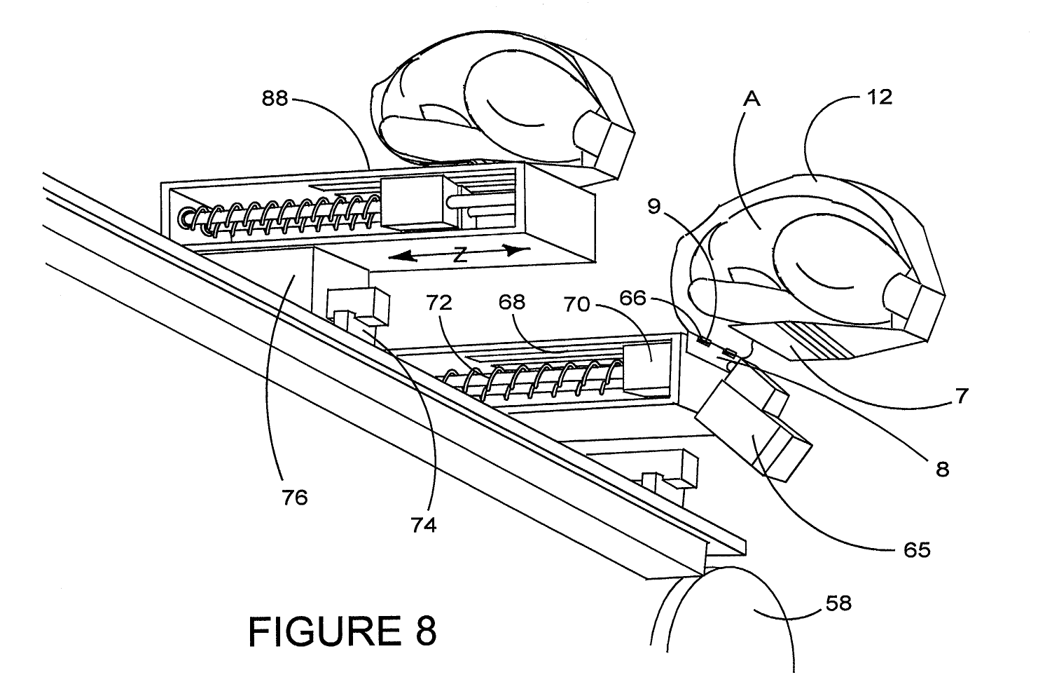

The guide assemblies 60 are moveable in a lateral plane by a cam track 78 and cam follower 74 mounted to the guide assemblies. One preferred embodiment of assembly is illustrated in FIGS. 7 and 8. The assembly 60 comprises one or more elements 66, 67 mounted in a corresponding track 68 to allow the elements to move in a planar direction Z (FIG. 8). Each element is mounted to a support member 70 which in turn is mounted to a shaft. The support member 70 is biased by biasing means 72 to be in an extended position designated as position K in FIG. 7. Biasing means may comprise a compression spring or other known suitable resilient biasing member. The body 76 of the guide assembly is mounted on a guide rail 79 to allow lateral movement as the cam follower follow the cam track 78.

In use, the elements 66, 67 are brought into alignment with the apertures 9 of the carton, by folding panel 8 out of alignment with panel 4. The guide assembly is moved laterally by the path of the cam to cause the elements to engage the apertures 9 as shown in FIG. 8. Glue is applied to the panel 8 by a glue gun 65 and as the carton moves downstream, the guide assembly continues to move laterally towards the article A. This movement causes panels 4 and 8 to wrap around the article A and into overlapping relationship with panel 7. The guide assemblies continue to move laterally so the carton panels become tensioned. The degree of tensioning is determined by the resilient means 72, so that once the pack has reach the desired level of tension the springs 72 will compress which will cause the body 70 and elements 66, 67 to move in the opposite direction to the guide assembly 60. This action makes the upper planar face 88 of the guide assembly slide underneath panel 8 and towards panel 7. Thereafter, panel 8 is brought into abutment with panel 7 to be secured therewith at position L on FIG. 7. Pressure is applied to the end flaps because the article is seated on face 88 with the panels 7, 8 placed therebetween.

The cam track causes the lateral movement of the guide assembly 60 to be reversed to facilitate the separation of the elements 66,67 from the carton and the biasing means causes the elements to return to the rest position.

As the package moves along to the outfeed end of the machine the overlapping panels may be placed on a plate 80 (FIG. 6) to aid the gluing process. Suitable guide means engages the package P, shown in FIG. 6 and transfers it back to the article conveyor 42 to the outfeed end. In this embodiment the guide means comprises an overhead chain assembly 82 and lug 84 and a fixed guide 86.

The machine 10 includes a controller arranged to control the speed of the conveyors 16, 18, 48, 82 during use so that packaging speeds of 40 to 60 pack per minute can be achieved. This controller may be a dedicated processor controlling the individual conveyors and the guide assembly or may be a control means for a packaging machine. Alternatively, the controller may preferably be a known, programmable servo control system.

In some embodiments, the controller receives information from a sensor (not shown) arranged to detect the speed of the continuous conveyors; which may detect the speed of the belt and/or position of the article or carton directly. In addition the apparatus may include means in the form of a sensor for receiving information regarding the speed of the cartons on the conveyor which is transmitted to the control means. Alternatively, there may be manual input means through which the speed of the cartons on the feed path may be input into the control means.

By pre-programming the control system, the adjustments to the machine required to change from packaging one carton type to another carton type can be pre-set.

According to this invention, the speed of operation of the apparatus is improved as well as its efficiency and durability. An advantage of the present invention is the flexibility offered by the system.

The packaging machine is capable of switching from one carton type or size to another with a minimal down time.

It will be recognised that the invention is not limited to cartons for poultry. The invention may be used with machines for packaging cans, paperboard ‘bricks’, bottles and other containers into cartons, but it is particularly useful where the article size may vary.

Further, the various elements of the machine, for example carton manipulating apparatus, folding apparatus, set up station, loading station or carton tightening means can be manufactured separately as a module to be incorporated into new machines or supplied on a retrofit basis without departing from the scope of invention.

It will be understood that the carton erecting mechanism and tightening mechanism of the invention has been illustrated with reference to a specific embodiment and that numerous modifications are possible within the scope of the invention. The carton tightening mechanism is able to process cartons comprising numerous configurations or groups of articles covering a range of carton size and shape, without undue time being spent in adjusting the mechanism.

1. Apparatus to tighten opposed ends of a wraparound carton around an article in a stream of articles of variable size during continuous forward movement, the apparatus comprising one or more panel engaging elements to engage one end panel of the carton, a guide assembly to guide the engaged end panel into overlapping relationship with the opposed end panel held by the apparatus, and a tightening device for tightening the carton panels around the article.

2. Apparatus as claimed in claim 1 wherein the engaging element is mounted to the guide assembly moveable in a transverse direction to the carton feed path to engage the end panel.

3. Apparatus as claimed in claim 2 wherein the transverse movement of the engaging element and guide assembly relative to the carton perpendicular to the carton feed direction is determined by cam means.

4. Apparatus as claimed in claim 3 wherein the cam means comprises a fixed cam track in which a cam follower attached to the guide assembly slidably fits.

5. Apparatus as claimed in claim 1 wherein the tightening device causes the engaging element to move from a deployed position to a retracted position when the desired panel tension is reached thereby to release the engaged end panel.

6. Apparatus as claimed in claim 5 wherein the tightening device includes a resilient biasing means to cause the engaging element to move between retraced and deployed positions.

7. Apparatus as claimed in claim 1 wherein the guide assembly is mounted on a continuous conveyor in a parallel plane to a carton conveyor.

8. Apparatus as claimed in claim 1 wherein further comprising panel securing means to cause the opposing ends of the carton to be placed in face contacting relationship to be secured therewith.

9. Apparatus as claimed in claim 8 wherein the panel securing means is further provided by a face of the guide assembly which face guides the overlapping panels in to abutment.

10. Apparatus as claimed in claim 9 wherein a glue gun is provided to apply a layer of glue to one of the end panels to secure the end panels in overlapping arrangement.

11. A packaging machine for continuously setting up and loading sleeve type cartons with one or more articles, for example, poultry comprising opposed side and end walls which machine comprises an article conveyor for conveying the articles through the machine, carton feed apparatus sequentially to deliver successive cartons from a supply in flat collapsed condition to a setting up station of the machine, panel folding devices to fold the carton into a set up wraparound condition, support means adapted to be brought into contact with the carton during movement downstream so that the carton is maintained in a set up condition and an article loading apparatus for loading at least one article into one or both ends of the carton, wherein there further comprises a carton tightening apparatus to cause the opposing ends of the carton to overlap and securing means to cause the overlapping panels to engage thereby to secure the carton in a set up condition.
